(19) United States
(12) Patent Application Publication
(10) Pub. No.: US 2024/0408865 A1
(43) Pub. Date: Dec. 12, 2024

(54) INK-JET RECORDING APPARATUS

(71) Applicant: KYOCERA Document Solutions Inc., Osaka (JP)

(72) Inventors: Naoto MIYASHITA, Osaka (JP); Yuzuru YUASA, Osaka (JP)

(73) Assignee: KYOCERA Document Solutions Inc., Osaka (JP)

(21) Appl. No.: 18/732,088

(22) Filed: Jun. 3, 2024

(30) Foreign Application Priority Data
Jun. 9, 2023 (JP) 2023-095446

(51) Int. Cl. B41J 2/045; B41J 2/165; B41J 13/08

(52) U.S. Cl. CPC B41J 2/04541; B41J 2/04581; B41J 2/04588; B41J 2/1652; B41J 13/08

(57) ABSTRACT

An ink-jet recording apparatus includes: a conveyor belt; a recording head including a pressurizing chamber that is configured to store ink, a nozzle that is configured to communicate with the pressurizing chamber, a displacement device that is configured to apply pressure to the pressurizing chamber by being deformed by application of voltage, and a driver circuit that is configured to switch the application of the voltage to the displacement device ON/OFF in response to a pulse drive signal input to the driver circuit; and a control unit. In a meniscus-shaking process before a flushing process, the control unit sets a pulse duration of the pulse drive signal to be smaller than a time constant of a circuit unit that includes the driver circuit and the displacement device.

### INCORPORATION BY REFERENCE

This application is based on and claims the benefit of priority from Japanese Patent Application No. 2023-095446 filed on Jun. 9, 2023, the contents of which are hereby incorporated by reference.

### BACKGROUND

The present disclosure relates to an ink-jet recording apparatus.

Related-art ink-jet recording apparatuses include recording heads that eject inks. In these related-art ink-jet recording apparatuses, the inks are ejected from the recording heads onto sheets. In this way, images are formed on the sheets.

### SUMMARY

An ink-jet recording apparatus according to an aspect of the present disclosure includes: a conveyor belt; a recording head; and a control unit.

The conveyor belt is configured to convey a sheet.

The recording head includes
a pressurizing chamber that is configured to store ink,
a nozzle that is configured to communicate with the pressurizing chamber,
a displacement device that is configured to apply pressure to the pressurizing chamber by being deformed by application of voltage, and
a driver circuit that is configured to switch the application of the voltage to the displacement device ON/OFF in response to a pulse drive signal input to the driver circuit, the recording head forming an image on the sheet by the application of the pressure to the pressurizing chamber to cause the ink to be ejected through the nozzle.

The control unit is configured to generate and input the pulse drive signal to the driver circuit,

The conveyor belt includes a flushing region in which an opening is formed.

The flushing region includes a plurality of flushing regions that are arrayed at an interval in a moving direction of the conveyor belt.

While the conveyor belt is driven, the control unit causes the recording head to execute a flushing process of ejecting the ink into the opening of a flushing region on which the sheet is absent among the plurality of flushing regions in addition to an image forming process of ejecting the ink onto the sheet.

Before the ink is ejected, the control unit causes the recording head to execute a meniscus-shaking process of shaking a meniscus of the ink in the nozzle by inputting the pulse drive signal for the meniscus-shaking process to the driver circuit and driving the displacement device.

In the meniscus-shaking process before the flushing process, the control unit sets a pulse duration of the pulse drive signal to be smaller than a time constant of a circuit unit that includes the driver circuit and the displacement device.

### BRIEF DESCRIPTION OF THE DRAWINGS

FIG. 1 is a schematic view of an ink-jet recording apparatus according to an embodiment;

FIG. 2 is a plan view of a recording section of the ink-jet recording apparatus according to the embodiment;

FIG. 3 is a schematic view of a conveyor belt and its vicinity of the ink-jet recording apparatus according to the embodiment;

FIG. 4 is a block diagram of the ink-jet recording apparatus according to the embodiment;

FIG. 5 is a block diagram of a recording head and its vicinity of the ink-jet recording apparatus according to the embodiment;

FIG. 6 is a schematic cross-sectional view illustrating a nozzle and its vicinity of the ink-jet recording apparatus according to the embodiment;

FIG. 7 is a plan view of a conveyor belt of the ink-jet recording apparatus according to the embodiment;

FIG. 8 is a view illustrating a positional relationship between a flushing region on the conveyor belt and the recording heads of the ink-jet recording apparatus according to the embodiment;

FIG. 9 is a view illustrating positional relationships between the flushing regions and sheets on the conveyor belt of the ink-jet recording apparatus according to the embodiment;

FIG. 10 is an explanatory view illustrating timings when the sheets are conveyed onto the conveyor belt of the ink-jet recording apparatus according to the embodiment;

FIG. 11 is a chart showing timings when the recording head of the ink-jet recording apparatus according to the embodiment executes a meniscus-shaking process;

FIG. 12 is a flowchart showing processes to be executed by a control unit of the ink-jet recording apparatus according to the embodiment;

FIG. 13 is a chart showing a relationship between voltage to be applied to piezoelectric devices of the ink-jet recording apparatus according to the embodiment and a pulse duration (chart showing a case where the pulse duration is set to be smaller than a time constant); and

FIG. 14 is a chart showing a relationship between the voltage to be applied to the piezoelectric devices of the ink-jet recording apparatus according to the embodiment and the pulse duration (chart showing a case where the pulse duration is set to be larger than the time constant).

### DETAILED DESCRIPTION

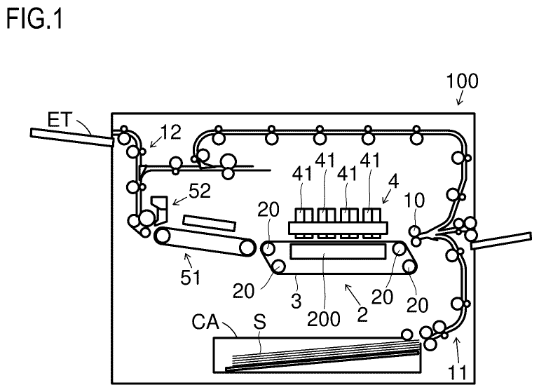

Now, with reference to FIG. 1 to FIG. 14, an embodiment of the present disclosure is described by using an example of a printer 100 that performs printing onto sheets S as recoding media. Types of the sheets S are not limited in particular. For example, paper is mainly used as the sheets S. Note that, in the following description, a direction that is perpendicular to an installation plane (such as flat floor surface) for the printer 100 is defined as a “vertical direction.”

### <Overall Configuration of Printer>

As illustrated in FIG. 1, a printer 100 according to this embodiment (corresponding to an “ink-jet recording apparatus”) includes a first conveying section 11 and a second conveying section 12. The first conveying section 11 feeds sheets S that are set in a sheet-feeding cassette CA, and conveys these sheets S to a printing position. In a print job by the printer 100, inks are ejected onto the sheets S that pass the printing position. With this, the images are printed onto the sheets S. In other words, in the print job by the printer 100, the images formed of the inks are formed on the sheets S. The second conveying section 12 conveys the printed sheets S. The second conveying section 12 discharges the recorded sheets S onto a discharge tray ET.

The first conveying section 11 includes a plurality of conveying roller members including a registration roller pair 10. In FIG. 1, only the registration roller pair 10 among the plurality of conveying roller members is denoted by its reference numeral. The plurality of conveying roller members are rotated to convey the sheets S. The registration roller pair 10 includes a pair of rollers that are held in press-contact with each other. A registration nip is formed between the pair of rollers that constitute the registration roller pair 10. The sheets S that have been fed from the sheet-feeding cassette CA enter the registration nip. The registration roller pair 10 is rotated to convey the sheets S to a belt conveyor section 2 described below.

Note that, at a time point when a leading edge of the sheet S reaches the registration nip, the rotation of the registration roller pair 10 has been stopped. Meanwhile, conveying roller members on an upstream side relative to the registration roller pair 10 among the conveying roller members in a conveying direction of the sheets S have been rotated. With this, skews of the sheets S are corrected.

The printer 100 includes the belt conveyor section 2. The belt conveyor section 2 receives the sheets S from the first conveying section 11, and conveys these sheets S. The belt conveyor section 2 includes a plurality of stretching rollers 20. The plurality of these stretching rollers 20 are supported to be rotatable. In addition, the belt conveyor section 2 includes a conveyor belt 3. The conveyor belt 3 is endless. The conveyor belt 3 is stretched to be rotatable by the plurality of stretching rollers 20. The sheets S are conveyed from the first conveying section 11 to the belt conveyor section 2, and these sheets S come onto an outer peripheral surface of the conveyor belt 3.

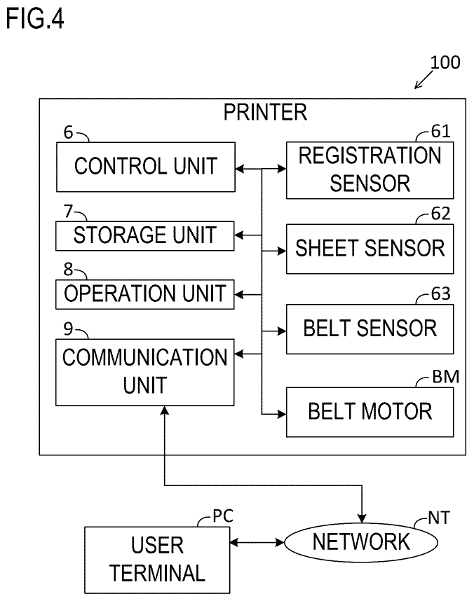

One of the plurality of stretching rollers 20 is coupled to a belt motor BM (refer to FIG. 4), and rotated by driving force that is transmitted from this belt motor BM. The conveyor belt 3 is driven by the rotation of the stretching roller 20 coupled to the belt motor BM, and other ones of the stretching rollers 20 are rotated in conjunction therewith. In other words, the conveyor belt 3 is rotated.

In addition, the belt conveyor section 2 includes a suction unit 200. The suction unit 200 is arranged on an inner peripheral side of the conveyor belt 3. The suction unit 200 sucks the sheets S on the outer peripheral surface of the conveyor belt 3 from the inner peripheral side of the conveyor belt 3.

Specifically, the conveyor belt 3 has a plurality of suction holes (not shown). The suction holes of the conveyor belt 3 are formed therethrough in a thickness direction of the conveyor belt 3. The suction unit 200 sucks the sheets S on the outer peripheral surface of the conveyor belt 3 through the suction holes of the conveyor belt 3. With this, the sheets S are sucked onto the outer peripheral surface of the conveyor belt 3. The conveyor belt 3 is rotated with the sheets S sucked and held on its outer peripheral surface. In other words, the conveyor belt 3 conveys the sheets S with the sheets S sucked on the outer peripheral surface. In still other words, the conveyor belt 3 conveys the sheets S by moving (that is, by being rotated). A direction in which the conveyor belt 3 is rotated corresponds to a “moving direction.”

The printer 100 includes a recording section 4. The recording section 4 is arranged to face the outer peripheral surface of the conveyor belt 3 in the vertical direction of the printer 100. While the sheets S are conveyed by the conveyor belt 3, the sheets S on the outer peripheral surface of the conveyor belt 3 and the recording section 4 face each other with a clearance therebetween in the vertical direction. With this, while the sheets S are conveyed by the conveyor belt 3, the sheets S pass between nozzle surfaces of recording heads 40 described below and the outer peripheral surface of the conveyor belt 3. In other words, the clearance between the nozzle surfaces of the recording heads 40 and the outer peripheral surface of the conveyor belt 3 form a part of a conveying path of the sheets S. Note that, the recording heads 40 are arranged over the conveyor belt 3, and the nozzle surfaces of the recording heads 40 are oriented downward.

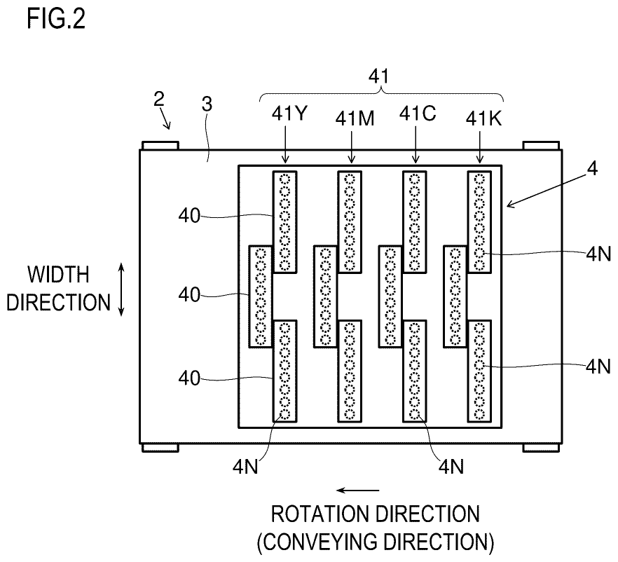

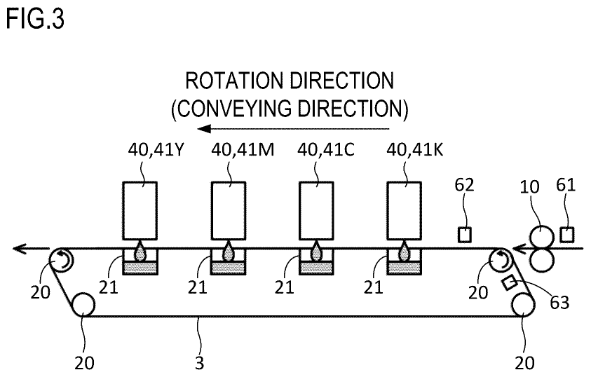

As illustrated in FIG. 2, the recording section 4 includes four line heads 41 corresponding respectively to colors of cyan, magenta, yellow, and black. In FIG. 2, these line heads 41 are distinguished from each other by adding a suffix “C” to a cyan line head 41, a suffix “M” to a magenta line head 41, a suffix “Y” to a yellow line head 41, and a suffix “K” to a black line head 41. The same applies to FIG. 3 to be referred to in the following description.

The line heads 41 corresponding respectively to the colors each include the plurality of (for example, three) recording heads 40. For example, the plurality of recording heads 40 corresponding respectively to the colors are arrayed in a staggered pattern in a direction that is orthogonal to the direction in which the sheets S are conveyed by the conveyor belt 3. In the following description, the direction that is orthogonal to the direction in which the sheets S are conveyed by the conveyor belt 3 is simply referred to as a “width direction.”

The recording heads 40 are arranged with the clearance in the vertical direction relative to the outer peripheral surface of the conveyor belt 3. In other words, the recording heads 40 are arranged at a position where the recording heads 40 face, in the vertical direction, the sheets S to be conveyed by the conveyor belt 3. In still other words, the conveyor belt 3 sucks and conveys the sheets S under the recording heads 40. A direction that is orthogonal to the direction in which the sheets S are conveyed by the conveyor belt 3 and to the width direction is the vertical direction.

The recording heads 40 each have, as the nozzle surface, a surface that faces the outer peripheral surface of the conveyor belt 3 in the vertical direction. The nozzle surface of each of the recording heads 40 includes a plurality of nozzles 4N. The plurality of nozzles 4N of each of the recording heads 40 eject an ink of a corresponding one of the colors downward. For example, the number of the nozzles 4N of each of the recording heads 40 is the same. The plurality of nozzles 4N of each of the recording heads 40 are arrayed along the width direction of the conveyor belt 3. In FIG. 2, the nozzles 4N are indicated by dotted circles. Actually, a larger number of the nozzles 4N are provided through each of the recording heads 40.

On the basis of data of the images to be printed on the sheets S in the print job, the recording heads 40 eject, through their nozzles 4N, the inks onto the sheets S on the outer peripheral surface of the conveyor belt 3. The inks that are ejected from the recording heads 40 adhere onto the sheets S. In this way, the images are formed on the sheets S. In other words, the clearance between the recording heads 40 and the conveyor belt 3 is the printing position, and the printing onto the sheets S is performed at this printing position.

Note that, as illustrated in FIG. 3, waste-ink tanks 21 are arranged on the inner peripheral side of the conveyor belt 3. The waste-ink tanks 21 pool inks that are ejected in a flushing process described below. These inks in the waste-ink tanks 21 are disposed of.

Referring back to FIG. 1, the printer 100 includes a drying unit 51 and a decurler 52. While the drying unit 51 conveys the sheets S to the decurler 52, the drying unit 51 dries the inks that have adhered to the sheets S being conveyed. The decurler 52 corrects curls of the sheets S. The decurler 52 conveys, to the second conveying section 12, the sheets S that have been subjected to the curl correction.

In addition, as shown in FIG. 4, the printer 100 includes a control unit 6. The control unit 6 includes a processing circuit including a CPU and an ASIC. The control unit 6 controls the print job. Specifically, the control unit 6 controls the belt motor BM to move (that is, to rotate) the conveyor belt 3 appropriately. The control unit 6 controls the conveyance of the sheets S by the conveyor belt 3. Further, the control unit 6 controls the ejection of the inks by the recording heads 40. Still further, although not described in detail here, the control unit 6 not only controls the flushing process, but also controls a meniscus-shaking process.

A registration sensor 61, a sheet sensor 62, and a belt sensor 63 are connected to the control unit 6. Detection positions (arrangement positions) of the registration sensor 61, the sheet sensor 62, and the belt sensor 63 are illustrated in FIG. 3.

The detection position of the registration sensor 61 is a position on an upstream side relative to the registration nip in the conveying direction of the sheets S. The registration sensor 61 is, for example, a reflective optical sensor or a transmissive optical sensor. The registration sensor 61 varies its output values in accordance with presence/absence of the sheets S at the corresponding detection position.

On the basis of the output values from the registration sensor 61, the control unit 6 detects whether or not the leading edge of the sheet S has reached the detection position of the registration sensor 61, and whether or not a trailing edge of the sheet S has passed the detection position of the registration sensor 61. In other words, on the basis of the output values from the registration sensor 61, the control unit 6 detects whether or not the leading edge of the sheet S has reached the registration nip, and whether or not the trailing edge of the sheet S has passed the registration nip. On the basis of a time period since the detection that the leading edge of the sheet S has reached the detection position of the registration sensor 61, the control unit 6 controls a timing to cause the registration roller pair 10 to start to convey the sheet S (timing to start the rotation of the registration roller pair 10).

The detection position of the sheet sensor 62 is a position between the printing position of a line head 41 on a most upstream side in the conveying direction of the sheets S among the plurality of line heads 41 and the registration nip. The sheet sensor 62 varies its output values in accordance with presence/absence of the sheets S at the corresponding detection position. A CIS (Contact Image Sensor) may be used as the sheet sensor 62. Alternatively, the reflective optical sensor or the transmissive optical sensor also may be used as the sheet sensor 62. For example, the CIS is used as the sheet sensor 62.

On the basis of the output values from the sheet sensor 62, the control unit 6 detects whether or not the leading edge of the sheet S has reached the detection position of the sheet sensor 62, and whether or not the trailing edge of the sheet S has passed the detection position of the sheet sensor 62. On the basis of the output values from the sheet sensor 62, the control unit 6 controls timings to eject the inks onto the sheets S to be conveyed by the conveyor belt 3. On the basis of a time period since the start of the conveyance of the sheets S by the registration roller pair 10, the control unit 6 may control the timings to eject the inks onto the sheets S to be conveyed by the conveyor belt 3.

Further, the control unit 6 measures a sheet-passage time period from a time point when a leading edge of a sheet S reaches the detection position of the sheet sensor 62 to a time point when a trailing edge of this sheet S passes the detection position of the sheet sensor 62. The sheet-passage time period at the detection position of the sheet sensor 62 varies depending on sizes in the conveying direction of the sheets S. Thus, on the basis of the sheet-passage time period, the control unit 6 recognizes the sizes in the conveying direction of the sheets S to be conveyed by the conveyor belt 3. With this, even when the sheets S to be conveyed by the conveyor belt 3 have non-standard sizes, the control unit 6 can detect these sizes in the conveying direction of the sheets S.

Still further, the control unit 6 detects misalignments of the sheets S (including skews of the sheets S) on the basis of the output values from the sheet sensor 62 (read data obtained through reading by the sheet sensor 62). For example, the misalignments of the sheets S may occur after the registration roller pair 10 has started to convey the sheets S. In this case, the misalignments of the sheets S are detected by the control unit 6.

Note that, the installed sheet sensor 62 includes a plurality of sheet sensors 62. For example, two sheet sensors 62 may be installed.

The belt sensor 63 is a sensor for detecting a preset reference position (home position) of the conveyor belt 3. A predetermined mark is provided at the reference position of the conveyor belt 3. With this, the reference position of the conveyor belt 3 can be detected on the basis of output values from the belt sensor 63. For example, the CIS may be used as the belt sensor 63. The reflective optical sensor or the transmissive optical sensor also may be used as the belt sensor 63.

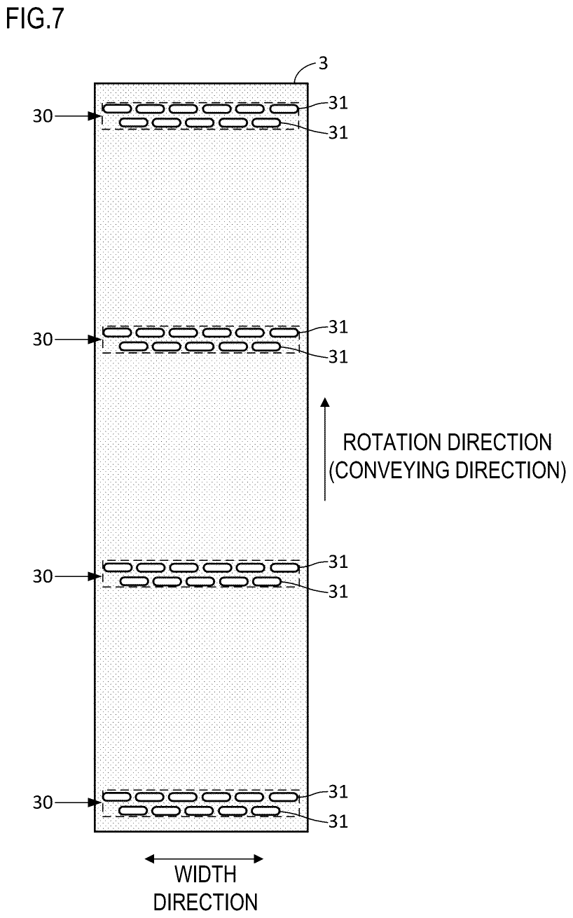

The control unit 6 detects the reference position of the conveyor belt 3 on the basis of the output values from the belt sensor 63. In other words, the control unit 6 detects a position of a flushing region 30 (refer to FIG. 7) in a rotation direction of the conveyor belt 3 on the basis of the output values from the belt sensor 63.

In addition, as shown in FIG. 4, the printer 100 includes a storage unit 7. The storage unit 7 includes storage devices such as a ROM, a RAM, an HDD, and an SSD. The storage unit 7 stores various information. The storage unit 7 is connected to the control unit 6. The control unit 6 reads the information from the storage unit 7. In addition, the control unit 6 writes information into the storage unit 7.

The printer 100 includes an operation panel 8. For example, a touchscreen is provided as the operation panel 8. The touchscreen displays, for example, software buttons and messages, and accepts touch operations by a user. In addition, the operation panel 8 also includes hardware buttons that accept settings, instructions, and the like. The operation panel 8 is connected to the control unit 6. The control unit 6 controls display operations of the operation panel 8 (touchscreen). In addition, the control unit 6 detects the operations to the operation panel 8.

The printer 100 includes a communication unit 9. The communication unit 9 includes a communication circuit. The communication unit 9 is connected to a user terminal PC via a network NT. The user terminal PC is an information processing apparatus such as a personal computer. The control unit 6 uses the communication unit 9 to communicate with the user terminal PC.

Print data of the print job (data including PDL data) is transmitted from the user terminal PC to the printer 100. In other words, a request to perform the print job is transmitted from the user terminal PC to the printer 100. The print data of the print job includes various setting data about printing, such as the sizes of the sheets S to be used in the print job. The communication unit 9 receives the print data of the print job. In response to the reception of the print data of the print job by the communication unit 9, the control unit 6 determines that the request to perform the print job is received.

### <Configuration to Eject Inks>

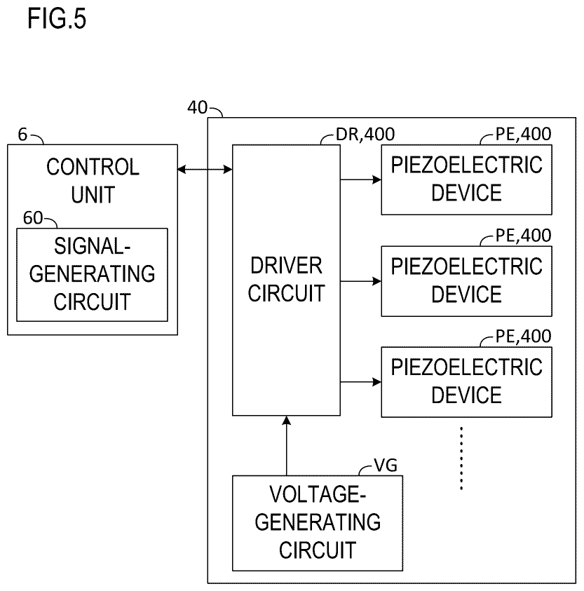

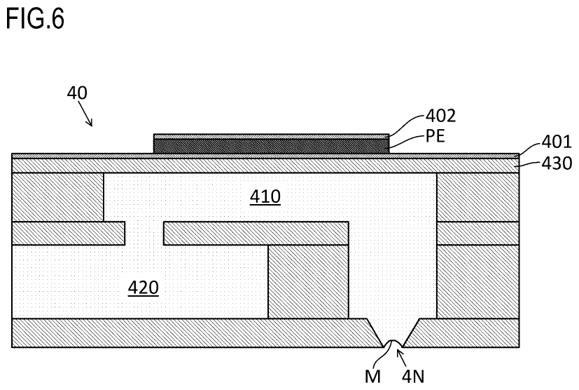

As shown in FIG. 5 and FIG. 6, the recording heads 40 each include piezoelectric devices PE. The piezoelectric devices PE correspond to “displacement devices.” The piezoelectric devices PE are allotted one by one to the nozzles 4N. The piezoelectric devices PE are driven and deformed by application of drive voltage. The nozzles 4N are caused to eject the ink by the deformation of corresponding ones of the piezoelectric devices PE.

Specifically, in each of the recording heads 40, a pressurizing chamber 410 is provided in each of the nozzles 4N. The pressurizing chambers 410 receive the ink that is supplied from an ink tank (not shown) via a common flow path 420. The pressurizing chambers 410 store the ink that is supplied from the ink tank. The pressurizing chambers 410 communicate with corresponding ones of the nozzles 4N. The piezoelectric devices PE are allotted one by one to the pressurizing chambers 410. By being driven and deformed, the piezoelectric devices PE apply pressure to the corresponding ones of the pressurizing chambers 410 to vary volumes of the pressurizing chambers 410. Note that, other displacement devices that vary the volumes of the pressurizing chambers 410 by being driven and deformed by the application of the voltage may be used instead of the piezoelectric devices PE.

The nozzles 4N eject the ink in response to the drive of the corresponding ones of the piezoelectric devices PE of the pressurizing chambers 410. In the meniscus-shaking process described below, the voltage is applied individually to the piezoelectric devices PE to an extent that the ink is not ejected through the nozzle 4N which is continuous with a corresponding one of the pressurizing chambers 410. With this, in the meniscus-shaking process, in each of the nozzles 4N, a meniscus of the ink can be shaken without causing the ink to be ejected. In FIG. 6, the meniscus of the ink is denoted by a reference symbol M.

The recording heads 40 each include a diaphragm 430. The diaphragm 430 constitutes an upper surface on a side that is opposite to a side where the nozzle surface is present in the vertical direction among wall surfaces of the recording head 40. A common electrode 401 is arranged on the diaphragm 430, and the piezoelectric device PE is arranged on this common electrode 401. An individual electrode 402 is arranged on the piezoelectric device PE. In other words, the piezoelectric device PE is sandwiched between a pair of electrodes in the vertical direction (that is, between the common electrode 401 and the individual electrode 402 in the vertical direction). Other ones of the piezoelectric devices PE are also arranged on the common electrode 401. The individual electrode 402 is arranged on each of the piezoelectric device PE.

The recording heads 40 each include a voltage-generating circuit VG. The recording heads 40 each include a driver circuit DR. The voltage-generating circuit VG generates the voltage that drives the piezoelectric devices PE, and supplies this voltage to the driver circuit DR. The driver circuit DR applies, to the piezoelectric devices PE, the drive voltage supplied from the voltage-generating circuit VG. In this way, the driver circuit DR drives and deforms the piezoelectric devices PE.

A pulse drive signal is input to the driver circuit DR. In response to a rise of this drive signal, the driver circuit DR applies the voltage to ones to be driven among the piezoelectric devices PE. In response to a fall of the drive signal, the driver circuit DR stops applying the voltage to the ones of the piezoelectric devices PE. In other words, in response to the input pulse-drive signal, the driver circuit DR switches the application of the voltage to the piezoelectric devices PE ON/OFF. Note that, the driver circuit DR does not apply the voltage to other ones not to be driven among the piezoelectric devices PE.

The driver circuit DR is connected to the control unit 6. The control unit 6 includes a signal-generating circuit 60 that generates the drive signal to the driver circuit DR. The signal-generating circuit 60 generates the pulse drive signal. This drive signal is a signal for cyclically drive the piezoelectric devices PE. The control unit 6 generates and inputs the drive signal to the driver circuit DR.

### <Configuration of Conveyor Belt>

As illustrated in FIG. 7, the conveyor belt 3 includes the flushing region 30. In FIG. 7, the flushing region 30 is surrounded by dashed lines. The flushing region 30 is a region in which openings 31 are formed through the conveyor belt 3 in its thickness direction. Although not described in detail here, in the flushing process, the inks are ejected from the recording heads 40. These ejected inks pass through the openings 31, reach the inner peripheral side of the conveyor belt 3, and are pooled in the waste-ink tanks 21.

Note that, the flushing region 30 provided on the conveyor belt 3 includes a plurality of flushing regions 30. The plurality of these flushing regions 30 are arranged at a predetermined interval in the rotation direction of the conveyor belt 3. The conveyor belt 3 includes the flushing regions 30 and other regions (reference symbols omitted) alternately to each other in the rotation direction.

The flushing regions 30 each include the plurality of (same number of) openings 31. The openings 31 are each a hole that is oblong in the width direction of the conveyor belt 3. The shape (shape as viewed in the thickness direction of the conveyor belt 3) of the openings 31 is not limited in particular. The shape of the openings 31 may be rectangular, circular, elliptical, or oval.

For example, the flushing regions 30 each include two opening rows. The opening rows are each a row of the openings 31 that are aligned at an equal interval in the width direction of the conveyor belt 3. One of the opening rows has N (six in FIG. 7) openings 31, and another one of the opening rows has N-1 (five in FIG. 7) openings 31. In addition, a center position in the width direction of each of the opening rows is arranged at a center position in the width direction of the conveyor belt 3. In other words, the plurality of openings 31 in each of the flushing regions 30 are arrayed in a staggered pattern in the width direction. Note that, a length in the width direction of each of the openings 31 (opening width) is larger than an interval between one opening 31 and another opening 31 that are adjacent to each other in the width direction.

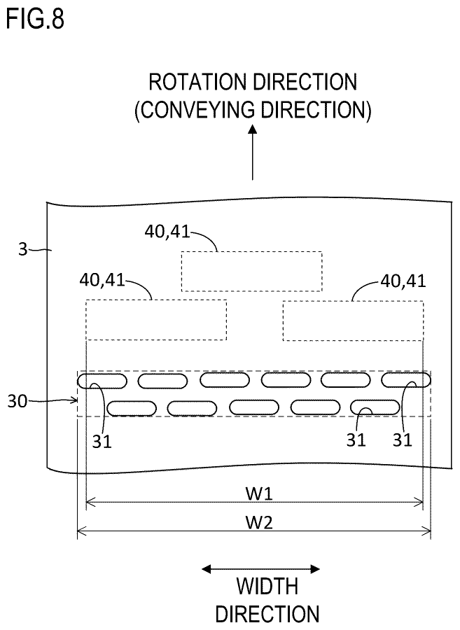

In addition, as illustrated in FIG. 8, a width W1 (mm) is smaller than a width W2 (mm). Note that, the width W1 corresponds to a length in the width direction of the line head 41. Specifically, the width W1 corresponds to a length in the width direction from an end on one side in the width direction of a recording head 40 that is located on the one side to an end on another side in the width direction of another recording head 40 that is located on the other side. The width W2 corresponds to a length in the width direction of the flushing region 30. Specifically, the width W2 corresponds to a length in the width direction from an end on the one side in the width direction of an opening 31 that is located most on the one side to an end on the other side in the width direction of another opening 31 that is located most on the other side.

With this, the plurality of nozzles 4N face at least any of the openings 31 in the vertical direction by the rotation of the conveyor belt 3.

### <Control on Conveyance of Sheets>

In a successive print job being a print job in which images are formed successively onto a plurality of sheets S that have the same size and that are sequentially conveyed by the conveyor belt 3, the control unit 6 performs control to cause a sheet-to-sheet interval being an interval in the conveying direction between a trailing edge of a preceding one of the sheets S and a leading edge of a subsequent one of the sheets S (sheet S that is conveyed after the preceding one of the sheets S) to be uniform. In other words, the control unit 6 performs control so that the plurality of sheets S are successively conveyed at a uniform interval. In still other words, the control unit 6 keeps uniform the sheet-to-sheet intervals to be formed in the successive conveyance of the plurality of sheets S.

In this context, in the successive print job, the control unit 6 recognizes the sizes of the sheets S to be conveyed by the conveyor belt 3. In addition, the control unit 6 detects the reference position of the conveyor belt 3. In addition, the control unit 6 controls the timing to start to convey the sheets S from the registration roller pair 10 to the conveyor belt 3 so that the flushing regions 30 come to the sheet-to-sheet interval in a predetermined cycle. In accordance with the sizes of the sheets S to be conveyed by the conveyor belt 3, the control unit 6 changes the timing to start to convey the sheets S from the registration roller pair 10 to the conveyor belt 3. Note that, on the basis of the print data of the print job, the control unit 6 recognizes the sizes of the sheets S to be used in the print job (sheets S to be conveyed by the conveyor belt 3).

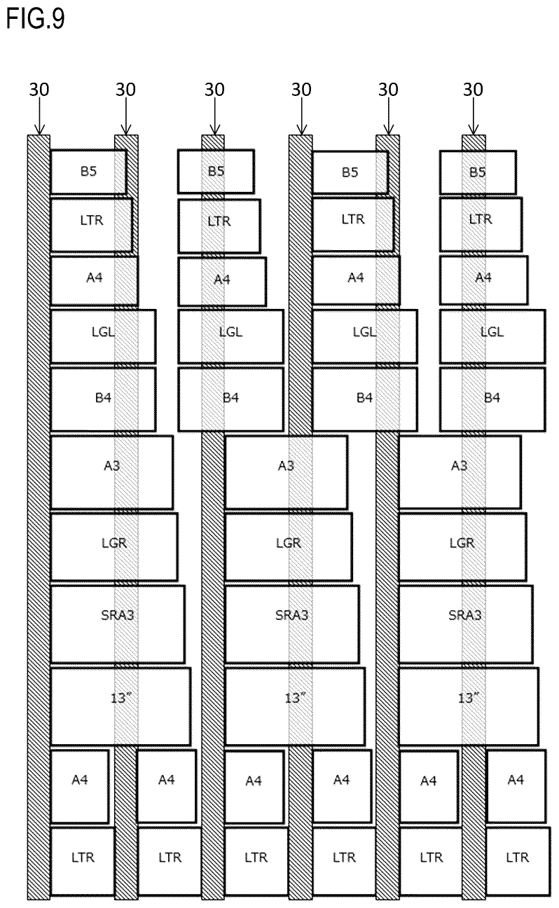

FIG. 9 illustrates positional relationships between the sheets S to be conveyed by the conveyor belt 3 and the flushing regions 30. In FIG. 9, the rotation direction of the conveyor belt 3 (that is, conveying direction of the sheets S) is a direction from the right to the left of the drawing sheet. In FIG. 9, the flushing regions 30 are indicated by hatching, and illustration of the openings 31 is omitted. In addition, in FIG. 9, the reference symbol S of the sheets S is omitted, and instead, the sizes of the sheets S are denoted in graphics representing the sheets S. Note that, in FIG. 9, for convenience, the sheets S of the plurality of difference sizes are collectively illustrated.

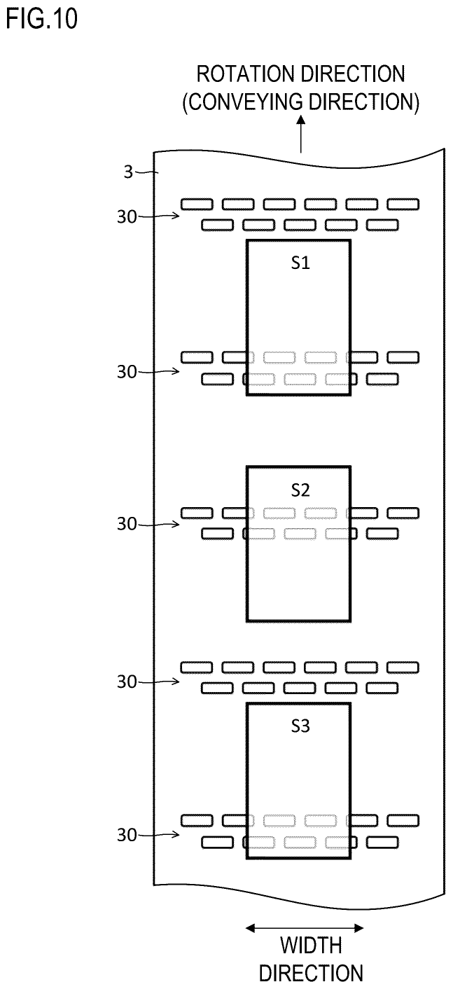

In this context, with reference to FIG. 10, detailed description is made with a focus on sheets S of an A4 portrait size (sheets S illustrated in a third row from the top in FIG. 9). In FIG. 10, the rotation direction of the conveyor belt 3 (that is, conveying direction of the sheets S) is a direction from the bottom to the top of the drawing sheet. In FIG. 10, for convenience, three of the sheets S are illustrated, and numbers 1 to 3 representing an order of the conveyance are added to the reference symbols S of these sheets S.

If the sheets S have the A4 portrait size, the flushing region 30 does not come to the sheet-to-sheet interval between a first sheet S1 and a second sheet S2. Meanwhile, the flushing region 30 comes to the sheet-to-sheet interval between the second sheet S2 and a third sheet S3. The flushing region 30 in the sheet-to-sheet interval between the sheet S2 and the sheet S3 does not overlap at all with either one of the sheet S2 and the sheet S3. Although not shown, the flushing region 30 does not come to the sheet-to-sheet interval between the third sheet S3 and a fourth sheet S4, and the flushing region 30 comes to the sheet-to-sheet interval between the fourth sheet S4 and a fifth sheet S5.

### <Outline of Flushing Process>

Viscosity of inks in nozzles 4N that are low in frequency of the ejection of the inks among the plurality of nozzles 4N increases over time. As a result, clogging occurs to cause image degradation. In order to suppress such an inconvenience, while the conveyor belt 3 is driven, the recording heads 40 execute the flushing process in addition to an image forming process. Note that, the image forming process is a process of forming the images on the sheets S by ejecting the inks onto the sheets S.

The flushing process is a process of ejecting the inks into the openings 31 of flushing regions 30 that have not overlapped with the sheets S among the plurality of flushing regions 30 on the conveyor belt 3. In other words, the flushing process is a process of ejecting the inks at timings different from timings when the images are formed on the sheets S. The inks to be ejected in the flushing process do not contribute to the image formation. The inks to be ejected in the flushing process do not head for the sheets S, and pass through the openings 31, reaches the inner peripheral side of the conveyor belt 3, and are pooled in the waste-ink tanks 21. The clogging is suppressed by executing the flushing process.

Now, a method of controlling the flushing process is described with a focus on a certain one of the recording heads 40. The following description is applied to methods of controlling the flushing process by other ones of the recording heads 40 to omit redundant description of these methods. The same applies to methods of controlling the meniscus-shaking process described below.

While the conveyor belt 3 is driven, the control unit 6 causes the recording head 40 to execute the flushing process at a timing when the flushing region 30 that has not overlapped with the sheets S and this recording head 40 face each other in the vertical direction. For example, in a single flushing process, the recording head 40 ejects ink through its nozzles 4N a plurality of times. At the timing when the recording head 40 faces the flushing region 30 in the vertical direction, the recording head 40 ejects the ink through the nozzles 4N, and causes the ink to pass through the openings 31. The ink to be ejected in the flushing process passes through the openings 31, and hence does not adhere to the conveyor belt 3.

In this context, in the successive print job, the conveyance of the sheets S is controlled so that the flushing regions 30 come to the sheet-to-sheet interval in the predetermined cycle. In other words, while the successive print job is performed, the flushing regions 30 that have not overlapped with the sheets S and the recording head 40 repeatedly face each other in the vertical direction.

Thus, while the successive print job is performed, the control unit 6 causes the recording head 40 to execute a plurality of times of the flushing process. While the successive print job is performed, the control unit 6 causes the recording head 40 to execute the flushing process every time the recording head 40 and the flushing region 30 face each other in the vertical direction.

### <Outline of Meniscus-Shaking Process>

If the ink in the nozzles 4N has become viscous and is forcibly ejected through the nozzles 4N, the ink to be ejected through the nozzles 4N may splash in an unexpected direction. For example, the ink adheres onto the conveyor belt 3. The ink adhering to the conveyor belt 3 may foul the sheets S to be conveyed by the conveyor belt 3.

In view of such circumstances, the recording head 40 executes the meniscus-shaking process of shaking the menisci of the ink in the nozzles 4N. The recording head 40 executes the meniscus-shaking process individually on the plurality of nozzles 4N. The recording head 40 executes the meniscus-shaking process before ejecting the ink. In other words, the recording head 40 executes the meniscus-shaking process before the flushing process (strictly, immediately before the flushing process). In addition, the recording head 40 executes the meniscus-shaking process also before the image forming process (strictly, immediately before the image forming process).

The control unit 6 controls the meniscus-shaking process by the recording head 40. The control unit 6 controls the number of times to shake the meniscus in the meniscus-shaking process (in other words, number of drive pulses to be applied to the piezoelectric device PE). The control unit 6 controls an amplitude of shaking the meniscus in the meniscus-shaking process (in other words, amplitude of the drive voltage to be applied to the piezoelectric device PE). In addition, the control unit 6 controls a timing to execute the meniscus-shaking process.

Before the ejection of the ink, the control unit 6 causes the recording head 40 to execute the meniscus-shaking process. At a time when the control unit 6 causes the recording head 40 to execute the meniscus-shaking process, the control unit 6 inputs the drive signal for the meniscus-shaking process to the driver circuit DR. With this, the drive voltage is applied to the piezoelectric device PE to be driven (in other words, a piezoelectric device PE that has been allotted to the nozzle 4N in which the meniscus of the ink should be shaken). In the meniscus-shaking process, slight voltage is applied as the drive voltage to the piezoelectric device PE. With this, the piezoelectric device PE is deformed to vibrate the diaphragm 430. At this time, this vibration is transmitted to the meniscus of the ink via the ink in the nozzle 4N. As a result, the meniscus of the ink is shaken.

By executing the meniscus-shaking process, the ink in the nozzle 4N is agitated. With this, the viscosity of the ink in the nozzle 4N is suppressed. Note that, even when the meniscus of the ink is shaken, an amplitude of this shaking is small. Thus, leakage of the ink through the nozzle 4N is suppressed.

### <Control on Amplitude of Meniscus Shaking>

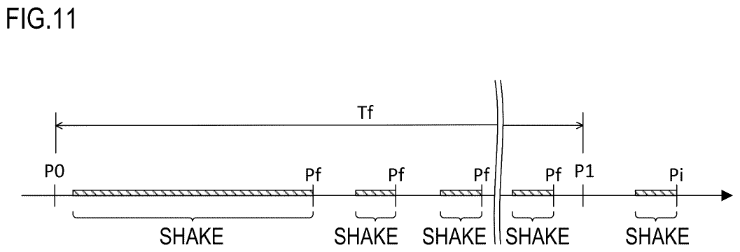

As shown in FIG. 11, in response to the request to perform a print job, the control unit 6 causes the conveyor belt 3 to start to be driven (time point P0). Subsequently, in a flushing term Tf being a term from a time point when a rotational speed of the conveyor belt 3 is stabilized to a constant speed to a time point P1 before the sheet S reaches the printing position, the control unit 6 causes the recording head 40 to execute the flushing process. Then, after the sheet S has reached the printing position, the control unit 6 causes the recording head 40 to execute the image forming process. In FIG. 11, “Pf” represents time points when the flushing process is executed, and “Pi” represents a time point when the image forming process is executed.

In the flushing term Tf, the control unit 6 causes the recording head 40 to execute the plurality of times of the flushing process on each of the plurality of nozzles 4N. In addition, before every time the flushing process is executed, the control unit 6 causes the recording head 40 to execute a plurality of times of the meniscus-shaking process individually on the plurality of nozzles 4N. In FIG. 11, terms in which the meniscus-shaking process is executed are indicated by hatching.

For example, in some cases, a term in which the ink has not been ejected since a last print job is performed until a current print job is performed may be long. As the term in which the ink has not been ejected becomes longer, the ink in the nozzles 4N is more liable to become viscous. Thus, the control unit 6 sets a term in which the meniscus-shaking process is executed to be longer before a first flushing process than before each of second and subsequent flushing processes in the flushing term Tf. In other words, the control unit 6 sets the number of times to execute the meniscus-shaking process to be larger before the first flushing process than before each of the second and the subsequent flushing processes in the flushing term Tf.

In this configuration, the number of the times to execute the meniscus-shaking process in the flushing term Tf increases. As the number of the times to execute the meniscus-shaking process becomes larger, the ink in the nozzle 4N can be further suppressed from becoming viscous. Meanwhile, if a large number of times of the meniscus-shaking process is executed, at the times when the meniscus-shaking process is executed, the ink may overflow through the nozzle 4N. If the ink overflows through the nozzle 4N at the times when the meniscus-shaking process is executed, the conveyor belt 3 is fouled with the ink.

In order to suppress this inconvenience, the control unit 6 performs control to reduce an amplitude of shaking the meniscus of the ink in the nozzle 4N in a meniscus-shaking process before the flushing process (that is, before ejection of the ink). Details of this control are described below. With this, the ink can be suppressed from overflowing through the nozzle 4N in the meniscus-shaking process before the flushing process.

Meanwhile, if the image forming process is executed with the ink in the nozzle 4N having become viscous, an inconvenience of the image degradation can occur. Thus, in the meniscus-shaking process before the image forming process, it is necessary to reliably suppress the ink in the nozzle 4N from becoming viscous.

In view of such circumstances, before every time the image forming process is executed (that is, before every time the ink is ejected), the control unit 6 causes the recording head 40 to execute the plurality of times of the meniscus-shaking process on a print-contributing nozzle 4N being a nozzle 4N to be used in the image forming process.

Note that, the control unit 6 performs control to set an amplitude of shaking a meniscus of the ink in the print-contributing nozzle 4N to be larger in an at least one meniscus-shaking process than those in other meniscus-shaking processes among the plurality of times of the meniscus-shaking process that the print-contributing nozzle 4N is caused to execute before the image forming process. Details of this control are described below.

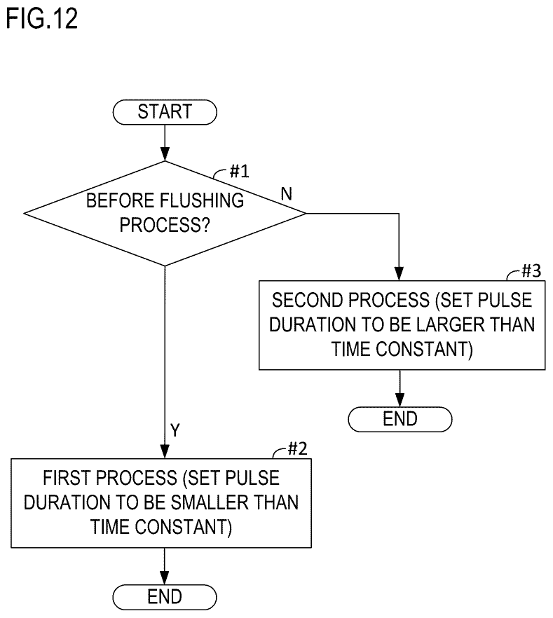

At a time when the control unit 6 causes the recording head 40 to execute the meniscus-shaking process, the control unit 6 executes processes in a procedure shown in FIG. 12. The meniscus-shaking process is executed individually on the nozzles 4N. In other words, the processes in the procedure shown in FIG. 12 are executed individually on the nozzles 4N.

For example, the flushing process is executed on all the nozzles 4N. In other words, the meniscus-shaking process before the flushing process is executed on all the nozzles 4N.

Meanwhile, in the image forming process, some of the nozzles 4N may not be used. The sheets S to be used in the print job are diverse. At least the nozzle 4N that does not face, in the vertical direction, the sheets S being conveyed by the conveyor belt 3 is not used in the image forming process. In addition, depending on the data of the images to be printed in the print job, the nozzle 4N that faces, in the vertical direction, the sheets S being conveyed by the conveyor belt 3 is not used in the image forming process.

In this way, in the print job, some of the nozzles 4N may not be used. The nozzles 4N that are not used in the print job do not eject ink in the image forming process, and hence the meniscus-shaking process before the image forming process is not executed on these nozzles 4N.

Note that, depending on the data of the images to be printed in the print job, one of the nozzles 4N may execute a plurality of times of the image forming process. In this case, every time this nozzle 4N executes the image forming process, the meniscus-shaking process is executed on this nozzle 4N.

At the time when the control unit 6 causes the recording head 40 to execute the meniscus-shaking process, the control unit 6 determines whether or not a meniscus-shaking process to be currently executed is the meniscus-shaking process before the flushing process (Step #1). If the meniscus-shaking process to be currently executed is the meniscus-shaking process before the flushing process, the procedure proceeds to Step #2. If the meniscus-shaking process to be currently executed is not the meniscus-shaking process before the flushing process, that is, the meniscus-shaking process before the image forming process, the procedure proceeds to Step #3.

If the procedure proceeds to Step #2, the control unit 6 executes a first process for reducing the amplitude of shaking the meniscus of the ink in the nozzle 4N. Meanwhile, if the procedure proceeds to Step #3, the control unit 6 executes a second process for increasing the amplitude of shaking the meniscus of the ink in the nozzle 4N.

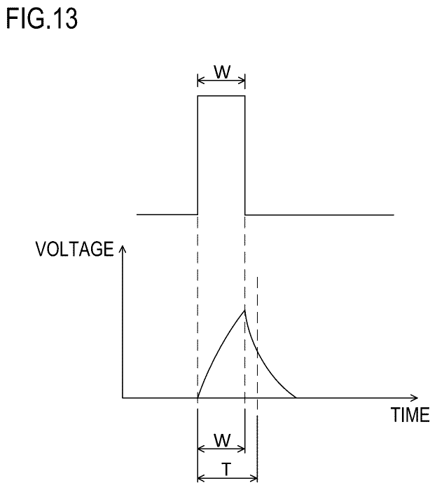

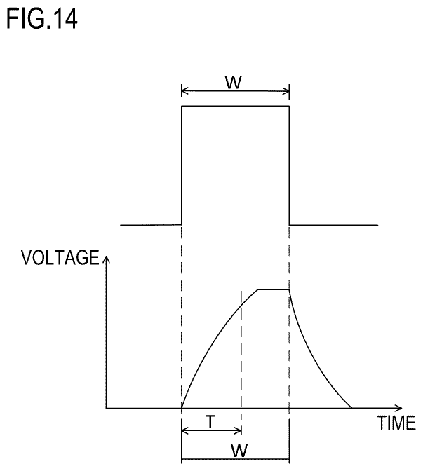

In these cases, the control unit 6 controls the amplitude of shaking the meniscus of the ink in the nozzle 4N by varying a pulse duration of the drive signal that is input to the driver circuit DR. Now, with reference to FIG. 13 and FIG. 14, details of the control are described. In the following description, a part including the driver circuit DR, the piezoelectric devices PE, and wire portions that connect these circuit and devices to each other is denoted by a reference numeral 400, and is referred to as a circuit unit 400 (refer to FIG. 5).

In FIG. 13 and FIG. 14, upper parts each show the pulse duration of the drive signal that is input to the driver circuit DR, and lower parts each show a transition of the drive voltage to be applied to the piezoelectric devices PE in response to the input of the drive signal to the driver circuit DR. Note that, the displacement of the piezoelectric devices PE depends on the drive voltage to be applied to the piezoelectric devices PE. In other words, in FIG. 13 and FIG. 14, the transitions of the drive voltage to be applied to the piezoelectric devices PE are also transitions of the displacement of the piezoelectric devices PE. In FIG. 13 and FIG. 14, “T” represents a time constant of the circuit unit 400, and “W” represents the pulse duration of the drive signal.

At the time when the control unit 6 causes the recording head 40 to execute the meniscus-shaking process before the flushing process, that is, at the time when the control unit 6 causes the amplitude of shaking the meniscus of the ink in the nozzle 4N to be small, the control unit 6 executes the first process of setting the pulse duration of the drive signal that is input to the driver circuit DR to be smaller than the time constant of the circuit unit 400. Meanwhile, at the time when the control unit 6 causes the recording head 40 to execute the meniscus-shaking process before the image forming process, that is, at the time when the control unit 6 causes the amplitude of shaking the meniscus of the ink in the nozzle 4N to be large, the control unit 6 executes the second process of setting the pulse duration of the drive signal that is input to the driver circuit DR to be larger than the time constant of the circuit unit 400.

In this embodiment, by executing the first process before the flushing process, as shown in FIG. 13, the voltage application to the piezoelectric device PE is stopped before the drive voltage that is applied to the piezoelectric device PE becomes steady. In other words, the voltage application to the piezoelectric device PE is stopped before the piezoelectric device PE is maximally displaced. With this, if the first process is executed, the amplitude of shaking the meniscus of the ink in the nozzle 4N is reduced.

Meanwhile, by executing the second process before the image forming process, as shown in FIG. 14, the voltage application to the piezoelectric device PE is stopped after the drive voltage that is applied to the piezoelectric device PE has become steady. In other words, the voltage application to the piezoelectric device PE is stopped after the piezoelectric device PE has been maximally displaced. With this, if the second process is executed, the amplitude of shaking the meniscus of the ink in the nozzle 4N is increased.

In this context, the amplitude of shaking the meniscus of the ink in the nozzle 4N in the meniscus-shaking process before the image forming process (hereinafter, also simply referred to as a “meniscus-shaking amplitude”) may be relatively large. In this case, the reduction of the meniscus-shaking amplitude in the meniscus-shaking process before the flushing process to be relatively smaller than the meniscus-shaking amplitude in the meniscus-shaking process before the image forming process may be insufficient to suppress the ink from overflowing through the nozzle 4N.

Meanwhile, in this embodiment, the meniscus-shaking amplitude before the flushing process is not simply reduced to be smaller than the meniscus-shaking amplitude before the image forming process. Specifically, at the time when the control unit 6 causes the recording head 40 to execute the meniscus-shaking process before the flushing process, the control unit 6 sets the pulse duration of the drive signal that is input to the driver circuit DR to be smaller than the time constant of the circuit unit 400. With this, the meniscus-shaking amplitude in the meniscus-shaking process before the flushing process can be reliably reduced. As a result, the ink can be suppressed from overflowing through the nozzle 4N in the meniscus-shaking process before the flushing process. In other words, the inks can be suppressed from unexpectedly overflowing through the nozzle 4N. If the inks can be suppressed from unexpectedly overflowing through the nozzle 4N, the conveyor belt 3 can be suppressed from being fouled with the ink.

In addition, in this embodiment, the amplitude of shaking the meniscus of the ink in the print-contributing nozzle 4N (that is, nozzle 4N to be used in the image forming process) is controlled to be larger in an at least one meniscus-shaking process than those in other meniscus-shaking processes among the plurality of times of the meniscus-shaking process that the print-contributing nozzle 4N executes before the image forming process.

For example, at the time when the control unit 6 causes the recording head 40 to execute the plurality of times of the meniscus-shaking process before the image forming process, the control unit 6 sets the pulse duration of the drive signal that is input to the driver circuit DR to be larger than the time constant of the circuit unit 400 in all the plurality of times of the meniscus-shaking process. In other words, although the plurality of times of the meniscus-shaking process is executed in the print-contributing nozzle 4N before the image forming process, the meniscus of the ink in the print-contributing nozzle 4N is relatively dynamically shaken in all the plurality of times of the meniscus-shaking process. With this, the ink can be reliably suppressed from becoming viscous in the print-contributing nozzle 4N.

In addition, for example, at the time when the control unit 6 causes the recording head 40 to execute the plurality of times of the meniscus-shaking process before the image forming process, the control unit 6 sets the pulse duration of the drive signal that is input to the driver circuit DR to be larger than the time constant of the circuit unit 400 in a predetermined number of times of the meniscus-shaking process among the plurality of times of the meniscus-shaking process, and sets the pulse duration of the drive signal that is input to the driver circuit DR to be smaller than the time constant of the circuit unit 400 in rest of the plurality of times of the meniscus-shaking process. In other words, although the plurality of times of the meniscus-shaking process is executed in the print-contributing nozzle 4N before the image forming process, the meniscus of the ink in the print-contributing nozzle 4N is relatively dynamically shaken only at a time when the predetermined number of times of the meniscus-shaking process among the plurality of times of the meniscus-shaking process is executed. With this, the ink can be suppressed from becoming viscous in the print-contributing nozzle 4N, and the ink can be suppressed from overflowing through the print-contributing nozzle 4N.

Note that, the predetermined number of times is not limited in particular. In addition, the pulse duration of the drive signal that is input to the driver circuit DR may be set to be larger than the time constant of the circuit unit 400 in a predetermined number of times of the meniscus-shaking process from a first one among the plurality of times of the meniscus-shaking process before the image forming process.

All the features of the embodiment disclosed herein are merely examples, and hence should not be regarded as limitations. The scope of the present disclosure is defined not by the embodiment described hereinabove but by the scope of claims, and encompasses meaning of equivalents of the elements described in the scope of claims and all modifications within the scope of claims.

What is claimed is:

1. An ink-jet recording apparatus, comprising:
a conveyor belt that is configured to convey a sheet;
a recording head including
a pressurizing chamber that is configured to store ink,
a nozzle that is configured to communicate with the pressurizing chamber,
a displacement device that is configured to apply pressure to the pressurizing chamber by being deformed by application of voltage, and
a driver circuit that is configured to switch the application of the voltage to the displacement device ON/OFF in response to a pulse drive signal input to the driver circuit, the recording head forming an image on the sheet by the application of the pressure to the pressurizing chamber to cause the ink to be ejected through the nozzle; and
a control unit that is configured to generate and input the pulse drive signal to the driver circuit,
the conveyor belt including a flushing region in which an opening is formed,
the flushing region including a plurality of flushing regions that are arrayed at an interval in a moving direction of the conveyor belt,
while the conveyor belt is driven, the control unit causing the recording head to execute a flushing process of ejecting the ink into the opening of a flushing region on which the sheet is absent among the plurality of flushing regions in addition to an image forming process of ejecting the ink onto the sheet,
before the ink is ejected, the control unit causing the recording head to execute a meniscus-shaking process of shaking a meniscus of the ink in the nozzle by inputting the pulse drive signal for the meniscus-shaking process to the driver circuit and driving the displacement device,
in the meniscus-shaking process before the flushing process, the control unit setting a pulse duration of the pulse drive signal to be smaller than a time constant of a circuit unit that includes the driver circuit and the displacement device.

2. The ink-jet recording apparatus according to claim 1, wherein, in the meniscus-shaking process before the image forming process, the control unit sets the pulse duration of the pulse drive signal to be larger than the time constant of the circuit unit.

3. The ink-jet recording apparatus according to claim 1, wherein,
the meniscus-shaking process includes a plurality of times of the meniscus-shaking process,
the control unit causes the recording head to execute the plurality of times of the meniscus-shaking process before the image forming process, and
the control unit
sets the pulse duration of the pulse drive signal to be larger than the time constant of the circuit unit in a predetermined number of times of the meniscus-shaking process among the plurality of times of the meniscus-shaking process before the image forming process, and
sets the pulse duration of the pulse drive signal to be smaller than the time constant of the circuit unit in rest of the plurality of times of the meniscus-shaking process.
